(19) United States
(12) Patent Application Publication
(10) Pub. No.: US 2005/0050439 A1
(43) Pub. Date: Mar. 3, 2005

(54) Method to distribute a document to one or more recipients and document distributing apparatus arranged in accordance with the same method

(75) Inventors: Carl F. Oresick, Webster, NY (US); Denise M. Kotalik, Rochester, NY (US); Keith S. Karn, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/650,552

(22) Filed: Aug. 28, 2003

(51) Int. Cl. G06F 17/00; G06F 17/21

(52) U.S. Cl. 715/500

(57) ABSTRACT

An originator distributes a document by a network to one or more recipients. The document comprises a cover sheet including cover sheet information. The originator provides document distribution job information in the cover sheet information. The document distribution job information includes an originator information including an originator network address and, for each recipient, a recipient information including a network address. The originator provides the document to a document distributing server. The server scans the document to provide the document distribution job information. The server then distributes the document to the recipients based on the document distribution job information. Each recipient receives the document, optionally modifies any of the information contained therein, and then returns the document to the server. The document distribution job continues until all recipients receive the document and return it to the server.

The applicants hereby incorporate by reference the disclosures of the following U.S. patent(s) verbatim and with the same effect as though all such disclosures were fully and completely set forth herein:
U.S. Pat. No. 5,459,307 to Leigh L. Klotz, Jr., entitled “System for storage and retrieval of digitally encoded information on a medium”, granted 17 Oct. 1995; and
U.S. Pat. No. 5,682,540 to Leigh L. Klotz, Jr. et al., entitled “System for representing electronic files using a paper based medium”, granted 28 Oct. 1997.

### FIELD OF THE INVENTION

This application relates generally to distributing documents, and more particularly to a method to distribute a document to one or more recipients by means of a network using a document distributing apparatus.

### BACKGROUND OF THE INVENTION

Currently there are no document routing systems that can handle items such as paper expense reports that require non-digital signature approvals. The majority of offices still rely on manual routing of paper documents and ink signatures. Automated document routing systems typically are client server applications, web based or otherwise, that rely upon electronic forms and digital signatures.

Hence, there is a need for a method to distribute a document to one or more recipients and document distributing apparatus arranged in accordance with the same method.

### BRIEF SUMMARY OF THE INVENTION

In a first aspect of the invention, there is described a method to distribute a document to one or more recipients by means of a network, the document comprising a cover sheet including a cover sheet information, each recipient having a recipient network address, the method comprising, by an originator having an originator network address:
(a) providing a document distribution job information in the cover sheet information, the document distribution job information including an originator information including the originator network address and, for each recipient, a recipient information including the recipient network address; and
(b) providing the document to an included document distributing apparatus.

In a second aspect of the invention, there is described a document distributing apparatus for distributing a document to one or more recipients by means of a network in accordance with a method, the document comprising a cover sheet including a cover sheet information, each recipient having a recipient network address, the method comprising, by an originator having an originator network address:
(a) providing a document distribution job information in the cover sheet information, the document distribution job information including an originator information including the originator network address and, for each recipient, a recipient information including the recipient network address; and
(b) providing the document to the document distributing apparatus.

### BRIEF DESCRIPTION OF THE SEVERAL VIEWS OF THE DRAWINGS

FIG. 1 depicts document distributing apparatus 10 that is arranged to distribute a document 9 to one or more recipients 1 through N by means of a communication network 20 in accordance with a method 100 in accordance with the present invention. N is any positive integer greater than zero such as 1, 2, 3, 4, 5, 6, or any greater number such as 16, 35, 42, 129, 558, 994, etc. As shown, the document 9 comprises a cover sheet 200 and, optionally, one or more document sheets 300. As shown, an originator 1 is provided with an originator document communication device 2. Also, each of the one or more recipients 1 through N is provided with a corresponding recipient document communication device 2-1 through 2-N. As shown, the originator document communication device 2 is coupled to the communication network 20 by means of a communication channel 3. Also, each of the recipient document communication devices 2-1 through 2-N is coupled to the communication network 20 by means of a corresponding communication channel 3-1 through 3-N. As shown, the document distributing apparatus 10 is coupled to the communication network 20 by means of a communication channel 4.

FIG. 2 depicts the FIG. 1 cover sheet 200. As shown, the cover sheet 200 includes a cover sheet information 201.

FIG. 3 depicts the FIG. 1 document sheet 300. As shown, the document sheet 300 includes a document sheet information 301.

FIGS. 4-6 depict a flow diagram of the method 100. As shown, the method 100 comprises an originator process 400 depicted in FIG. 4 as 100a, an apparatus process 500 depicted in FIG. 5 as 100b, and a recipient process 600 depicted in FIG. 6 as 100c.

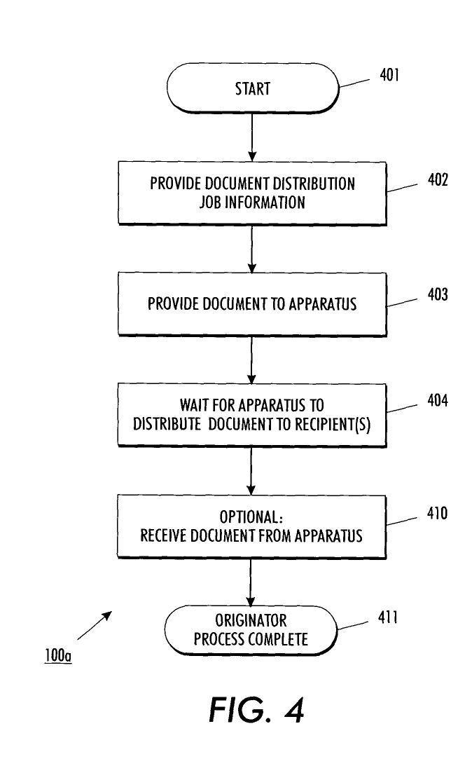

As depicted in FIG. 4, the originator process 400 is performed by the originator 1.

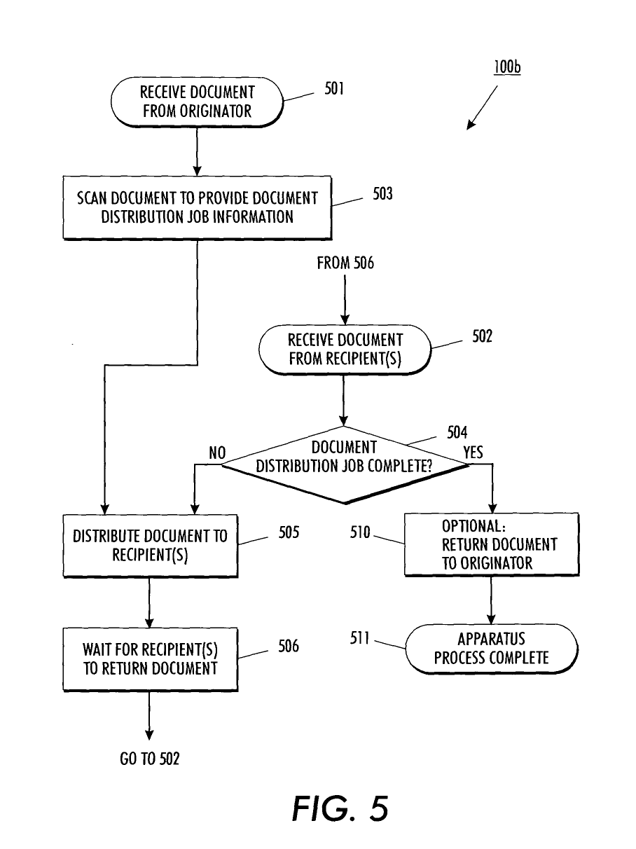

As depicted in FIG. 5, the apparatus process 500 is performed by the document distributing apparatus 10.

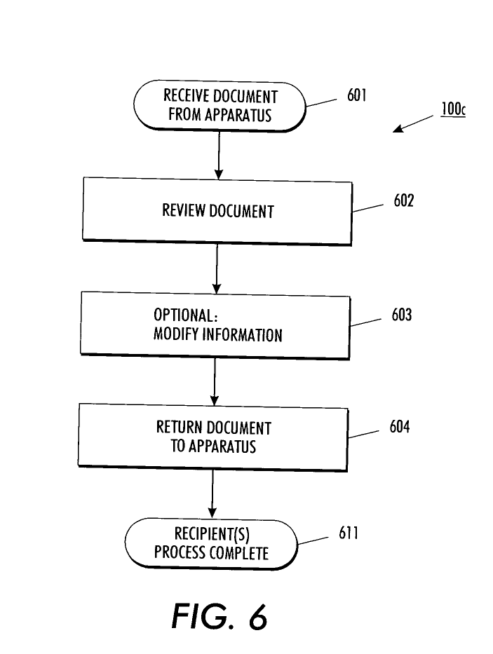

As depicted in FIG. 6, the recipient process 600 is performed by the recipients 1 through N.

### DETAILED DESCRIPTION OF THE INVENTION

Briefly, an originator distributes a document by means of a communication network to one or more recipients. The document comprises a cover sheet containing a cover sheet information. In one embodiment, the document also comprises one or more document sheets containing a document sheet information. The originator provides a document distribution job information in the cover sheet information. The document distribution job information includes an originator information including an originator network address and, for each recipient, a recipient information including a network address. The originator provides the document to a document distributing apparatus. The document distributing apparatus scans the document to provide the document distribution job information. The document distributing apparatus then distributes the document to the recipients based on the document distribution job information. Each recipient receives the document from the document distributing apparatus, optionally modifies any of the information contained therein, and then returns the document to the document distributing apparatus. The recipient optionally modifies any information by physically marking any of the cover sheet and the optional one or more document sheets. This optional sheet marking by the recipient is accomplished by means of a marking instrument such as a pencil, pen, crayon, or the like. The document distribution job continues until all recipients receive the document and return it to the document distributing apparatus. In one embodiment, when the document distributing apparatus determines that the document distribution job is complete, the document distributing apparatus returns the document to the originator.

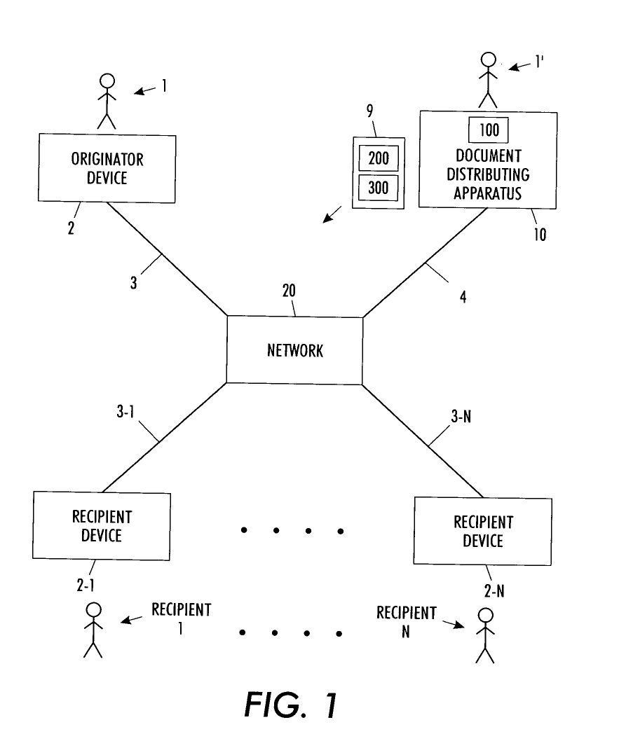

Referring now to FIG. 1 there is depicted document distributing apparatus 10 for distributing a document 9 to one or more recipients 1 through N in accordance with a method 100 of the present invention. As shown, the document 9 comprises a cover sheet 200 and, optionally, one or more document sheets 300. Also shown is an originator 1.

As shown, the document distributing apparatus 10 is coupled to a communication network 20 by means of the communication channel 4.

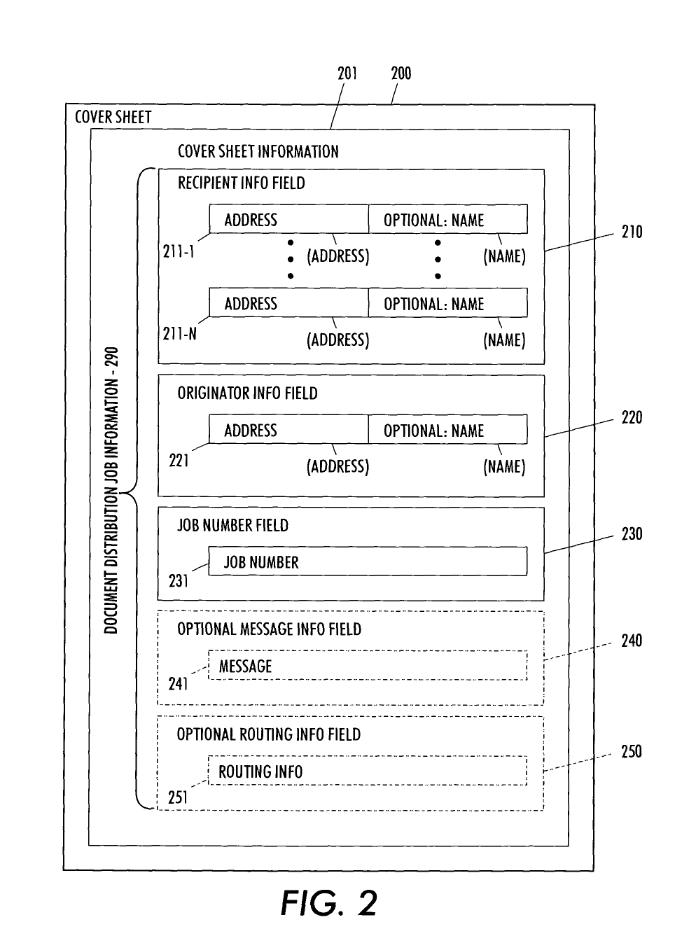

Referring now to FIG. 2 there is depicted the FIG. 1 cover sheet 200. As shown, the cover sheet 200 includes a cover sheet information 201.

The cover sheet information 201 comprises a document distribution job information 290.

The document distribution job information 290 comprises a recipient information field 210, an originator information field 220 and a document distribution job number field 230.

The recipient information field 210 comprises a recipient information 211 for each recipient, recipient 1 through N. As depicted, the recipient information 211-1 corresponds to the recipient 1, and so forth for each individual recipient 2, 3, 4, and so forth, with the recipient information 211-N corresponding to the recipient N.

As depicted, for each recipient of recipient 1 through recipient N, the recipient's corresponding recipient information 211 includes the recipient's network address.

For example, FIG. 2 depicts the network address for recipient 1 as 211-1 (Addrs). Also, FIG. 2 depicts the network address for recipient N as 211-N (Addrs).

In one embodiment, for each recipient of recipient 1 through recipient N, the recipient's corresponding recipient information 211 also includes the recipient's name.

For example, FIG. 2 depicts the name of recipient 1 as 211-1 (Name). Also, FIG. 2 depicts the name of recipient N as 211-N (Name).

The originator information field 220 comprises an originator information 221. The originator information 221 includes the originator's network address, depicted as 221 (Addrs). In one embodiment, the originator information 221 also includes the originator's name, depicted as 221 (Name).

The document distribution job number field 230 comprises a document distribution job number 231.

In one embodiment, the document distribution job information 290 comprises an optional message information field 240. The message information field 240 contains a message 241.

In one embodiment, the document distribution job information 290 comprises an optional routing information field 250. The routing information field 250 contains a routing information 251.

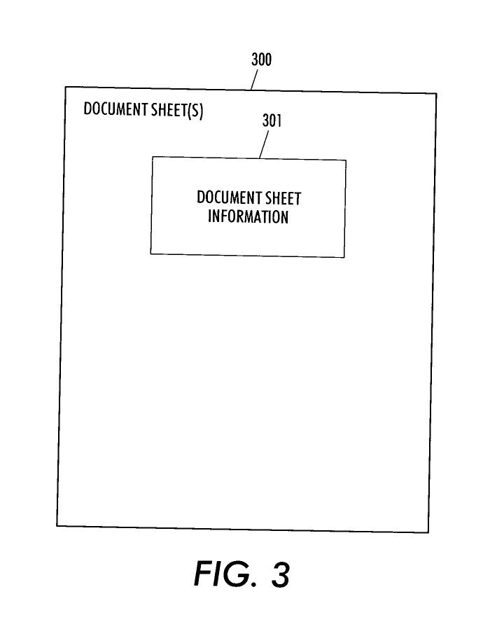

Referring now to FIG. 3 there is depicted the FIG. 1 optional document sheet 300. As shown, the optional document sheet 300 includes a document sheet information 301.

Referring now to FIGS. 4-6 there is a flow diagram of the method 100. As shown, the method 100 comprises an originator process 400 depicted in FIG. 4 as 100a, a document distributing apparatus process 500 depicted in FIG. 5 as 100b, and a recipient process 600 depicted in FIG. 6 as 100c.

Referring now to FIG. 4 there is depicted the originator process 400 that is performed by the originator 1.

The originator process 400 starts at step 401, and then goes to step 402.

In step 402, the originator 1 provides a document distribution job information 290 in the cover sheet information 201, the document distribution job information including an originator information including the originator network address and, for each recipient, a recipient information including the recipient network address.

Thus, with cross-reference to FIG. 2, in step 402 the originator provides an originator information 221 including an originator network address 221 (Addrs) in an originator information field 220 and, for each recipient of recipient 1 through recipient N, a recipient information 211-1 through 211-N including a recipient network address 211-1 (Addrs) through 211-N (Addrs) in a recipient information field 210.

In one embodiment, in step 401, the originator 1 also provides a document distribution job number 231 in a document distribution job number field 230.

Also, in one embodiment, in step 402, the originator 1 also provides an optional message information 241 in a message information field 240.

Also, in one embodiment, in step 402, the originator 1 also provides an optional routing information 251 in a routing information field 250.

After completing step 402, the process goes to step 403.

In step 403, the originator 1 provides the document 9 to the document distributing apparatus 10.

For good understanding, the present document providing step 403 that is performed by the originator 1 corresponds to the document receiving step 501 which is performed by the document distributing apparatus 10 and which is discussed in connection with FIG. 5 below.

Still referring to step 403 in FIG. 4, with momentary cross-reference to FIG. 1, in one embodiment the originator 1 will be located in a different location situated some physical distance away from the document distributing apparatus 10. In this embodiment, the originator 1 is provided with an originator document communication device 2 coupled to the communication network 20 by means of a communication channel 3 and so the FIG. 4 step 402 includes a step by the originator 1 of sending the document 9 to the document distributing apparatus 10 by means of the originator document communication device 2, the communication channel 3, the communication network 20, and the communication channel 4. For example, as depicted in FIG. 1, the originator 1 provides or sends the document 9 to the document distributing apparatus 10 by means of the originator document communication device 2, the communication channel 3, the communication network 20 and the communication channel 4. In one embodiment, the originator document communication device 2 comprises any of (i) a fax terminal and (ii) one or more devices arranged to provide functions of email, scan and print.

In an alternate embodiment the originator, depicted in FIG. 1 by the alternate reference number 1′, will be located in the same location situated proximate to the document distributing apparatus 10. In this embodiment, the originator 1′ will physically present or tender the document 9 to the document distributing apparatus 10.

Referring to step 403 in FIG. 4, after completing step 403, the process goes to step 404.

In step 404, the originator 1 waits for the document distributing apparatus 10 to distribute the document 9 to all recipients 1 through N.

For good understanding, the present waiting step 404 that is performed by the originator 1 corresponds to the distributing process 500 steps 501, 502, 503, 504, 505 and 506 which are performed by the document distributing apparatus 10 and which are discussed in connection with FIG. 5 below and to the recipient process 600 which is performed by the recipients 1 through N and which are discussed in connection with FIG. 6 below.

After the document distributing apparatus 10 distributes the document 9 to all recipients 1 through N, the step 404 is complete.

In one embodiment, after completing step 404 the originator process 400 goes to step 411, and the originator process 400 is complete.

However, in another embodiment, after completing step 404 the process goes to optional step 410.

In optional step 410, the originator 1 receives the document 9 which is returned by the document distributing apparatus 10.

For good understanding, the present optional document receiving step 410 that is performed by the originator 1 corresponds to the optional document returning step 510 which is performed by the document distributing apparatus 10 and which is discussed in connection with FIG. 5 below.

After completing the optional step 410, the originator process 400 goes to step 411, and the originator process 400 is complete.

Referring now to FIG. 5 there are depicted the document distributing apparatus process 500 that is performed by the document distributing apparatus 10.

In step 501, the document distributing apparatus 10 receives the document 9 from the originator 1.

For good understanding, the present document receiving step 501 that is performed by the document distributing apparatus 10 corresponds to the document providing step 403 which is performed by the originator 1 and which is discussed in connection with FIG. 4 above.

After step 501 is complete, the process goes to step 503.

In step 503, the document distributing apparatus 10 scans the document 9 to provide the document distribution job information 290.

After completing step 503, the process goes to step 505.

In step 505, the document distributing apparatus 10 distributes the document 9 by means of the communication network 20 to one or more recipients based on the job distribution information 201.

For good understanding, the present document distributing step 505 that is performed by the document distributing apparatus 10 corresponds to the document receiving step 601 which is performed by the recipients 1 through N and which is discussed in connection with FIG. 6 below.

For example, as depicted in FIG. 1, the document distributing apparatus 10 distributes or sends the document 9 to the recipient 1 by means of the communication channel 4, the communication network 20, the communication channel 3-1, and the recipient 1 document communication device 2-1. Also for example, as depicted in FIG. 1, the document distributing apparatus 10 distributes or sends the document 9 to the recipient N by means of the communication channel 4, the communication network 20, the communication channel 3-N, and the recipient N document communication device 2-N.

Still referring to step 505, in one embodiment, the document distributing apparatus 10 distributes or sends the document 9 to one or more recipients in a sequential manner.

Still referring to step 505, in one embodiment, the document distributing apparatus 10 distributes or sends the document 9 to one or more recipients in a parallel manner.

After completing step 505, the process goes to step 506.

In step 506, the document distributing apparatus 10 waits for the one or more recipients 1 through N to return the document 9 to the document distributing apparatus 10.

For good understanding, the present waiting step 506 that is performed by the document distributing apparatus 10 corresponds to the steps 602-603 which are performed by the one or more recipients 1 through N and which are discussed in connection with FIG. 6 below.

After completing step 506, the process goes to step 502.

In step 502, the document distributing apparatus 10 receives the document 9 from the one or more recipients.

For good understanding, the present document receiving step 502 that is performed by the document distributing apparatus 10 corresponds to the document returning step 604 which is performed by the one or more recipients 1 through N and which is discussed in connection with FIG. 6 below.

After completing step 502, the process goes to step 504.

In step 504, the document distributing apparatus 10 determines when the current document distribution job is complete.

Still referring to step 504, when the determining step 504's result is negative (a step 504 negative result depicted in FIG. 5 as “NO”), that is, when the document distributing apparatus 10 determines that the current document distribution job is not complete, the process returns to step 505, where the document distributing apparatus 10 continues to distribute the document 9 to the remaining recipients based on the document distribution job information 290.

Otherwise, in one embodiment, still referring to step 504, when the determining step 504's result is positive (a step 504 positive result depicted in FIG. 5 as “YES”), that is, when the document distributing apparatus 10 determines that the current document distribution job is complete, the process goes directly to step 511, and the document distributing apparatus process 500 is complete.

Still referring to step 504, in another embodiment, when the document distributing apparatus 10 determines in step 504 that the current document distribution job is complete, thus yielding a positive (“YES”) result, then the process goes to an optional step 510.

In optional step 510, the document distributing apparatus 10 returns the document 9 to the originator 1.

For good understanding, the present optional document returning step 510 that is performed by the document distributing apparatus 10 corresponds to the optional document receiving step 410 which is performed by the originator 1 and which is discussed in connection with FIG. 4 above.

For example, as depicted in FIG. 1, the document distributing apparatus 10 returns or sends the document 9 to the originator 1 by means of the communication channel 4, the communication network 20, the communication channel 3, and the originator document communication device 2. After optional step 510, the process then goes to step 511, and the document distributing apparatus process 500 is complete.

Referring now to FIG. 6 there is depicted the recipient process 600. As depicted, the recipient process 600 is performed by the recipients 1 through N.

In step 601, the recipient receives the document 9 from the document distributing apparatus 10.

For good understanding, the present document receiving step 601 that is performed by the recipients 1 through N corresponds to the document distributing step 505 which is performed by the document distributing apparatus 10 and which is discussed in connection with FIG. 5 above.

For example, as depicted in FIG. 1, the recipient 1 receives the document 9 from the document distributing apparatus 10 by means of the corresponding recipient 1 document communication device 2-1, the communication channel 3-1, the communication network 20 and the communication channel 4. Also, as depicted in FIG. 1, the recipient N receives the document 9 from the document distributing apparatus 10 by means of the corresponding recipient N document communication device 2-N, the communication channel 3-N, the communication network 20 and the communication channel 4.

After completing step 601, the process goes to step 602.

In step 602, the recipient reviews the document 9, the document 9 comprising the cover sheet 200 including the cover sheet information 201 and the one or more document sheets 300 including a document sheet information 301.

After completing step 602, in one embodiment, the process goes directly to step 604.

In step 604, the recipient returns the document 9 to the document distributing apparatus 10. For example, as depicted in FIG. 1, the recipient 1 returns or sends the document 9 to the document distributing apparatus 10 by means of the corresponding recipient 1 document communication device 2-1, the communication channel 3-1, the communication network 20 and the communication channel 4. Also, as depicted in FIG. 1, the recipient N returns or sends the document 9 to the document distributing apparatus 10 by means of the corresponding recipient N document communication device 2-N, the communication channel 3-N, the communication network 20 and the communication channel 4.

After completing step 604, the process goes to step 611.

In step 611, the recipient process 600 is complete.

Returning to step 602, in one embodiment, after completing the step 602, the process goes to the optional step 603.

In optional step 603, the recipient modifies any of the cover sheet information 201 and the document sheet information 301 as comprised in the document 9. After completing optional step 603, the process goes to step 604, as discussed above.

Referring still to the optional step 603, in one embodiment, the recipient modifies any of the cover sheet information 201 and the document information 301 by physically marking any of the cover sheet 200 and the one or more document sheets 300. In one embodiment, the recipient marks any of the cover sheet 200 and the one or more document sheets 300 by means of a marking instrument such as, for example, a pencil, pen, crayon, or the like.

Referring now generally to FIG. 1, in one embodiment, the originator document communicating device 2 comprises any of (i) a tax terminal and (ii) one or more devices arranged to provide functions of email, scan and print.

Also, in one embodiment, each of the recipient document communicating devices 2-1 through 2-N comprises any of (i) a fax terminal and (ii) one or more devices arranged to provide functions of email, scan and print.

In one embodiment, the communication network 20 comprises a public telephone network.

In one embodiment, the communication network 20 comprises an internet.

In one embodiment, the communication network 20 comprises a wireless or radio frequency network.

In one embodiment, the document 9 comprises a purchase order.

In one embodiment, the document 9 comprises an expense report.

In one embodiment, the document 9 comprises a time card.

Thus there has been described the first aspect of the invention, that is, the method 100 (comprising the originator process 400 in FIG. 4, the document distributing apparatus process 500 in FIG. 5 and the recipient process 600 in FIG. 6) to distribute a document 9 to one or more recipients 1 through N by means of a network 20, the document 9 comprising a cover sheet 200 including a cover sheet information 201, each recipient of recipient 1 through recipient N having a recipient network address (respectively depicted in FIG. 2 as 211-1 (Addrs) through 211-N (Addrs)), the method 100 comprising, by an originator 1 having an originator network address (depicted in FIG. 2 as 221 (Addrs)):
(a) providing (in originator step 402) a document distribution job information 290 in the cover sheet information 201, the document distribution job information 290 including an originator information 220 including the originator network address 221 (Addrs) and, for each recipient (respectively, the recipients 1 through N), a recipient information (respectively, depicted in FIG. 2 as 211-1 through 211-N) including the recipient network address (respectively, respectively depicted in FIG. 2 as 211-1 (Addrs) through 211-N (Addrs)); and
(b) providing (in originator step 403) the document 9 to an included document distributing apparatus 10.

Also, there has been described the second aspect of the invention, that is, the document distributing apparatus 10 for distributing a document 9 to one or more recipients 1 through N by means of a network 20 in accordance with a method 100 (comprising the originator process 400 in FIG. 4, the document distributing apparatus process 500 in FIG. 5 and the recipient process 600 in FIG. 6), the document 9 comprising a cover sheet 200 including a cover sheet information 20i, each recipient of recipient 1 through recipient N having a recipient network address (respectively depicted in FIG. 2 as 211-1 (Addrs) through 211-N (Addrs)), the method 100 comprising, by an originator 1 having an originator network address (depicted in FIG. 2 as 221 (Addrs)):
(a) providing (in originator step 402) a document distribution job information 290 in the cover sheet information 201, the document distribution job information 290 including an originator information 220 including the originator network address 221 (Addrs) and, for each recipient (respectively, the recipients 1 through N), a recipient information (respectively, depicted in FIG. 2 as 211-1 through 211-N) including the recipient network address (respectively, respectively depicted in FIG. 2 as 211-1 (Addrs) through 211-N (Addrs)); and
(b) providing (in originator step 403) the document 9 to the document distributing apparatus 10.

In one embodiment, the document distributing apparatus 10 comprises a document distributing server.

The present disclosure is a process and apparatus to automatically route documents such as purchase orders, expense reports, time cards, etc. Typically these types of documents require human signature or annotation at each stage of their workflow process prior to being forwarded to the next recipient(s). The means to facilitate this automatic routing is by means of a FLOWPORT PAPERWARE form cover sheet that embeds routing information in a “glyph”. The terms “FLOWPORT” and “PAPERWARE” are trademarks of the Xerox Corporation, Stamford, Conn. This cover sheet is placed on top of the document to be routed and scanned in an apparatus enabled to work with the FLOWPORT scan distribution server. The scanned cover sheet and document are sent electronically to the FLOWPORT distribution server, where the cover sheet and glyph-embedded routing information is decoded. Based on this routing information, a new cover sheet and/or glyph is generated and forwarded along with the document to the next recipient's email or other repository for hardcopy generation, signature, and rescanning with the new cover sheet to the next embedded destination.

The table below lists the drawing element reference numbers together with their corresponding written description:

| Number: | Description: |
|---|---|
| 1 | originator (remote from the document distributing |
| | apparatus) |
| 1′ | originator (proximate to the document distributing |
| | apparatus) |
| 2 | originator document communication device |
| 2-1 through 2-N | recipient document communication devices |
| 3 | originator communication channel |
| 3-1 through 3-N | recipient communication channels |
| 4 | document distribution apparatus communication |
| | channel |
| 9 | document |
| 10 | document distributing apparatus |
| 20 | communication network |
| 100 | method to distribute a document to one or more |
| | recipients |
| 200 | cover sheet |
| 201 | cover sheet information |
| 210 | recipient information field |
| 211 | recipient information |
| 211-1 | recipient 1 recipient information |
| 211-1 (Addrs) | recipient 1 network address |
| 211-1 (Name) | recipient 1 name |
| 211-N | recipient N recipient information |
| 211-N (Addrs) | recipient N network address |
| 211-N (Name) | recipient N name |
| 220 | originator information field |
| 221 | originator information |
| 221 (Addrs) | originator network address |
| 221 (Name) | originator name |
| 230 | document distribution job number field |
| 231 | document distribution job number |
| 240 | message information field |
| 241 | message |
| 250 | routing information field |
| 251 | routing information |
| 290 | document distribution job information |
| 300 | optional document sheet |
| 301 | document sheet information |
| 400 | originator process |
| 401 | originator start |
| 402 | originator provide document distribution job |
| | information |
| 403 | originator provide document to apparatus |
| 404 | originator wait for apparatus to distribute document |
| 410 | (optional) originator receive document from apparatus |
| 411 | originator process complete |
| 500 | document distribution apparatus process |
| 501 | apparatus receive document from originator |
| 502 | apparatus receive document from recipient(s) |
| 503 | apparatus scan document |
| 504 | apparatus determine when document distribution job |
| | complete |
| 505 | apparatus distribute document to recipient(s) |
| 506 | apparatus wait for recipient(s) to return document |
| 510 | (optional) apparatus return document to originator |
| 511 | apparatus process complete |
| 600 | recipient process |
| 601 | recipient receive document from apparatus |
| 602 | recipient review document |
| 603 | (optional) recipient modify any of the cover sheet |
| | information |
| | and the document sheet information |
| 604 | recipient return document to apparatus |
| 611 | recipient process complete |

While various embodiments of a method to distribute a document to one or more recipients and document distributing apparatus arranged in accordance with the same method, in accordance with the present invention, have been described hereinabove, the scope of the invention is defined by the following claims.

1. A method to distribute a document to one or more recipients by means of a network, the document comprising a cover sheet including a cover sheet information, each recipient having a recipient network address, the method comprising, by an originator having an originator network address:
(a) providing a document distribution job information in the cover sheet information, the document distribution job information including an originator information including the originator network address and, for each recipient, a recipient information including the recipient network address; and
(b) providing the document to an included document distributing apparatus.

2. The method of claim 1 including, by the originator, sending the document to the document distributing apparatus by means of an included network.

3. The method of claim 2, the originator document sending performed by means of an included originator document communication device.

4. The method of claim 1, the document distribution job information providing step (a) including providing a message information.

5. The method of claim 1, the document distribution job information providing step (a) including providing a routing information.

6. The method of claim 1 including, by the document distributing apparatus:
(c) receiving the document from the originator;
(d) scanning the document to provide the document distribution job information; and
(e) distributing the document by means of an included network to one or more recipients based on the job distribution information.

7. The method of claim 6 including, by a recipient:
(f) receiving the document from the document distributing apparatus; and
(g) returning the document to the document distributing apparatus.

8. The method of claim 7 including, by the recipient, modifying the cover sheet information.

9. The method of claim 8 including, by the recipient, marking the cover sheet.

10. The method of claim 9 including, by the recipient, marking the cover sheet by means of a marking instrument.

11. The method of claim 10, the marking instrument comprising any of a pencil, pen, crayon, or the like.

12. The method of claim 7, the document comprising one or more document sheets including a document sheet information, the method including, by the recipient, modifying any of the cover sheet information and the document sheet information.

13. The method of claim 12 including, by the recipient, marking any of the cover sheet and the one or more document sheets.

14. The method of claim 13 including, by the recipient, marking any of the cover sheet and the one or more document sheets by means of a marking instrument.

15. The method of claim 14, the marking instrument comprising any of a pencil, pen, crayon, or the like.

16. The method of claim 7, the recipient document receiving performed by means of an included corresponding recipient document communication device.

17. The method of claim 16, the recipient document communication device comprising any of (i) a fax terminal and (ii) one or more devices arranged to provide functions of email, scan and print.

18. The method of claim 7 including, by the document distributing apparatus:
(h) receiving the document from the recipient; and
(i) determining when the document distribution job is complete.

19. The method of claim 18 including, by the document distributing apparatus, when it is determined that the document distribution job is complete, returning the document to the originator.

20. The method of claim 19 including, by the document distributing apparatus, sending the document to the originator by means of the network.

21. The method of claim 18 including, by the document distributing apparatus, when it is determined that the document distribution job is not complete, distributing the document to one or more recipients based on the document distribution job information.

22. The method of claim 18, the network comprising a public telephone network.

23. The method of claim 18, the network comprising an internet.

24. The method of claim 18, the network comprising a wireless or radio frequency network.

25. The method of claim 18, the document comprising any of a purchase order, expense report and time card.

26. Document distributing apparatus for distributing a document to one or more recipients by means of a network in accordance with a method, the document comprising a cover sheet including a cover sheet information, each recipient having a recipient network address, the method comprising, by an originator having an originator network address:
(a) providing a document distribution job information in the cover sheet information, the document distribution job information including an originator information including the originator network address and, for each recipient, a recipient information including the recipient network address; and
(b) providing the document to an included document distributing apparatus.

27. The document distributing apparatus of claim 26 the method including, by the originator, sending the document to the document distributing apparatus by means of an included network.

28. The document distributing apparatus of claim 27, the originator document sending performed by means of an included originator document communication device.

29. The document distributing apparatus of claim 26, the document distribution job information providing step (a) including providing a message information.

30. The document distributing apparatus of claim 26, the document distribution job information providing step (a) including providing a routing information.

31. The document distributing apparatus of claim 26 the method including, by the document distributing apparatus:
(c) receiving the document from the originator;
(d) scanning the document to provide the document distribution job information; and
(e) distributing the document by means of an included network to one or more recipients based on the job distribution information.

32. The document distributing apparatus of claim 31 the method including, by a recipient:
(f) receiving the document from the document distributing apparatus; and
(g) returning the document to the document distributing apparatus.

33. The document distributing apparatus of claim 32 the method including, by the recipient, modifying the cover sheet information.

34. The document distributing apparatus of claim 33 the method including, by the recipient, marking the cover sheet.

35. The document distributing apparatus of claim 34 the method including, by the recipient, marking the cover sheet by means of a marking instrument.

36. The document distributing apparatus of claim 35, the marking instrument comprising any of a pencil, pen, crayon, or the like.

37. The document distributing apparatus of claim 32, the document comprising one or more document sheets including a document sheet information, the method including, by the recipient, modifying any of the cover sheet information and the document sheet information.

38. The document distributing apparatus of claim 37 the method including, by the recipient, marking any of the cover sheet and the one or more document sheets.

39. The document distributing apparatus of claim 38 the method including, by the recipient, marking any of the cover sheet and the one or more document sheets by means of a marking instrument.

40. The document distributing apparatus of claim 39, the marking instrument comprising any of a pencil, pen, crayon, or the like.

41. The document distributing apparatus of claim 32, the recipient document receiving performed by means of an included corresponding recipient document communication device.

42. The document distributing apparatus of claim 41, the recipient document communication device comprising any of (i) a fax terminal and (ii) one or more devices arranged to provide functions of email, scan and print.

43. The document distributing apparatus of claim 32 the method including, by the document distributing apparatus:
(h) receiving the document from the recipient; and
(i) determining when the document distribution job is complete.

44. The document distributing apparatus of claim 43 the method including, by the document distributing apparatus, when it is determined that the document distribution job is complete, returning the document to the originator.

45. The document distributing apparatus of claim 44 the method including, by the document distributing apparatus, sending the document to the originator by means of the network.

46. The document distributing apparatus of claim 43 the method including by the document distributing apparatus, when it is determined that the document distribution job is not complete, distributing the document to one or more recipients based on the document distribution job information.

47. The document distributing apparatus of claim 43, the network comprising a public telephone network.

48. The document distributing apparatus of claim 43, the network comprising an internet.

49. The document distributing apparatus of claim 43, the network comprising a wireless or radio frequency network.

50. The document distributing apparatus of claim 43, the document comprising any of a purchase order, expense report and time card.

51. The document distributing apparatus of claim 31 comprising a document distributing server.
